(19) United States
(12) Patent Application Publication
(10) Pub. No.: US 2018/0025880 A1
(43) Pub. Date: Jan. 25, 2018

(54) THIN PROTECTION ELEMENT

(71) Applicants: Changwei Ho, New Taipei (TW); Suzhou Join Technology Innovation, Suzhou (CN)

(72) Inventors: Changwei Ho, New Taipei (TW); Haifeng Wang, Suzhou (CN); Yi Chen, Suzhou (CN)

(21) Appl. No.: 15/648,713

(22) Filed: Jul. 13, 2017

(30) Foreign Application Priority Data
Jul. 19, 2016 (TW) 105122670

(51) Int. Cl. H01H 85/143; H01H 85/06; H01H 85/08; H01H 85/12

(52) U.S. Cl. CPC H01H 85/143; H01H 85/12; H01H 85/06; H01H 85/08

(57) ABSTRACT

Disclosed is a thin protection element having at least two electrodes provided installed on an insulating substrate and provide for electrically connecting an external circuit, a fuse structure electrically coupled between the at least two electrodes and provided for fusing at a predetermined temperature, and a shielding structure for at least shielding the fuse structure. The shielding structure is made of an insulating thermoplastic material and directly coated onto a surface of the fuse structure by a film formation technology, and deformable to cope with the protrusion of the melted fuse structure to prevent the fuse structure from being ruined or damaged by the protrusion of the fuse structure. The invention can reduce the total volume of the protection element and facilitate the development of thin products effectively.

### FIELD OF INVENTION

The present invention relates to an overcurrent/overvoltage protection element, and more specifically relates to a thin protection element capable of reducing the volume effectively for the thin design of products.

### BACKGROUND OF INVENTION

### 1. Description of the Related Art

As we all know, a general overcurrent/overvoltage protection element (hereinafter referred to as “protection element”) is primarily provided for protecting a circuit or an electric appliance to prevent a precision electronic device from being damaged by an instantaneous too-large current or voltage. When the instantaneous too-large current exceeds a predetermined current value, a fuse structure made of an alloy and installed in the protection element will be melted by high temperature of the heat produced by the instantaneous too-large current to form a short circuit, so that the too-large current will not flow into the circuit anymore, so as to protect the circuit and electric appliance.

With reference to FIG. 1 for a conventional protection element, the conventional protection element comprises two electrodes 12 installed on an insulating substrate 11, a fuse structure 13 made of a low melting point alloy and coupled between the two electrodes 12, and a shielding structure 14 coated onto the insulating substrate 11 for at least shielding the fuse structure to prevent the fuse structure from being oxidized and the metal of peripheral electronic components or circuits from being melted.

The portion of the fuse structure 13 melted at high temperatures is in form of a protrusion as shown in the figure due to the cohesion phenomenon, and most conventional protection elements having the shielding structure 14 are made of a rigid material and fixed onto the insulating substrate 11 by assembling or adhesion to prevent the melted portion of the fuse structure 13 from being ruined or damaged, so that it is necessary to have a space between the melted portion and the fuse structure 13.

However, such arrangement cannot reduce the volume of the protection element effectively and is unfavorable for the development of thin products. Particularly, the production of the protection element requires the formation and assembling of the shielding structure 14, and thus incurring more manufacturing time, higher manufacturing cost, or even a lower yield rate of the protection element caused by poor assembling of the shielding structure 14.

### 2. Summary of the Invention

In view of the drawbacks of the conventional protection element the present invention provides a thin protection element capable of reducing the volume effectively to facilitate the development of thin products.

To achieve the aforementioned and other objectives, the present invention provides a thin protection element comprising: at least two electrodes installed on an insulating substrate and provided for electrically coupling an external circuit; a fuse structure electrically coupled between the at least two electrodes for fusing at a predetermined temperature; and a shielding structure for at least shielding the fuse structure, characterized in that the shielding structure is made of an insulating thermoplastic material and directly coated onto a surface of the fuse structure by a film formation technology.

According to the aforementioned technical characteristics, the thin protection element of the present invention has a shielding structure deformable according to the protrusion of the melted fuse structure when a surge current exceeds a predetermined current value and the fuse structure is melted by high temperature, and produces an excellent ductility at the high temperature, so that the protruded fuse structure will not be ruined or damaged easily, and the invention can reduce the total volume of the protection element effectively to facilitate the development of thin products

According to the aforementioned technical characteristics, the fuse structure is made of an alloy.

According to the aforementioned technical characteristics, the fuse structure is formed by stacking two metal layers of different melting points.

According to the aforementioned technical characteristics, the fuse structure has a high melting point metal layer and a low melting point metal layer sequentially installed from bottom to top.

According to the aforementioned technical characteristics, the fuse structure has a low melting point metal layer and a high melting point metal layer sequentially installed from bottom to top.

According to the aforementioned technical characteristics, the fuse structure has a low melting point metal layer and a high melting point metal layer sequentially installed from bottom to top.

According to the aforementioned technical characteristics, the fuse structure has a high melting point metal layer, a low melting point metal layer and a high melting point metal layer sequentially installed from bottom to top.

According to the aforementioned technical characteristics, the fuse structure has a low melting point metal layer, a high melting point metal layer and a low melting point metal layer sequentially installed from bottom to top.

According to the aforementioned technical characteristics, the fuse structure has a high melting point metal layer, a high melting point metal layer and a low melting point metal layer sequentially installed from bottom to top.

According to the aforementioned technical characteristics, the fuse structure has a low melting point metal layer, a high melting point metal layer, a high melting point metal layer and a low melting point metal layer sequentially installed from bottom to top.

According to the aforementioned technical characteristics, the fuse structure has a high melting point metal layer, a low melting point metal layer, a high melting point metal layer and a high melting point metal layer sequentially installed from bottom to top.

According to the aforementioned technical characteristics, the fuse structure has a high melting point metal layer, a high melting point metal layer, a low melting point metal layer and a high melting point metal layer sequentially installed from bottom to top.

According to the aforementioned technical characteristics, the fuse structure has a high melting point metal layer, a high melting point metal layer, a high melting point metal layer and a low melting point metal layer sequentially installed from bottom to top.

According to the aforementioned technical characteristics, the fuse structure has a tin layer made of tin and a copper layer made of copper; the tin layer and the copper layer have a volume ratio of 30:1˜120:1; the copper layer has a thickness falling within a range of 0.1˜2 μm; and the tin layer has a thickness falling within a range of 3˜240 μm.

According to the aforementioned technical characteristics, the fuse structure has a tin layer made of tin and a copper layer made of copper; the tin layer and the copper layer have a volume ratio of 60:1; the copper layer has a thickness of 1.5 μm; and the tin layer has a thickness of 90 μm.

According to the aforementioned technical characteristics, the fuse structure has a tin layer made of tin and a nickel layer made of nickel; the tin layer and the nickel layer have a volume ratio of 50:1˜160:1; the nickel layer has a thickness falling within a range of 0.1˜2 μm; and the tin layer has a thickness falling within a range of 5˜320 μm.

According to the aforementioned technical characteristics, the fuse structure has a tin layer made of tin and a nickel layer made of nickel; the tin layer and the nickel layer have a volume ratio of 90:1; the nickel layer has a thickness of 1 μm; and the tin layer has a thickness of 90 μm.

According to the aforementioned technical characteristics, the fuse structure has a tin layer made of tin and a silver layer made of silver; the tin layer and the silver layer have a volume ratio of 25:1˜110:1; the silver layer has a thickness falling within a range of 0.1˜2 μm; and the tin layer has a thickness falling within a range of 2.5˜220 μm.

According to the aforementioned technical characteristics, the fuse structure has a tin layer made of tin and a silver layer made of silver; the tin layer and the silver layer have a volume ratio of 50:1; the silver layer has a thickness of 1.5 μm; and the tin layer has a thickness of 75 μm.

According to the aforementioned technical characteristics, the fuse structure has a tin layer made of tin, a copper layer made of copper, and a silver layer made of silver; the tin layer, the copper layer and the silver layer have a volume proportion of 60:1:1˜240:1:1; the copper layer plus the silver layer have a total thickness falling within a range of 0.2˜4 μm; and the tin layer has a thickness falling within a range of 6˜480 μm.

According to the aforementioned technical characteristics, the fuse structure has a tin layer made of tin, a copper layer made of copper, and a silver layer made of silver; the tin layer, the copper layer and the silver layer have a volume proportion of 120:1:1; the copper layer plus the silver layer have a total thickness of 1.5 μm; and the tin layer has a thickness of 90 μm.

According to the aforementioned technical characteristics, the fuse structure has a tin layer made of tin, a nickel layer made of nickel, and a copper layer made of copper; the tin layer, the nickel layer and the copper layer have a volume proportion of 100:0.5:1˜320:0.5:1; the nickel layer plus the copper layer have a thickness falling within a range of 0.15˜3 μm; and the tin layer has a thickness falling within a range of 10˜640 μm.

According to the aforementioned technical characteristics, the fuse structure has a tin layer made of tin, a nickel layer made of nickel, and a copper layer made of copper; the tin layer, the nickel layer and the copper layer have a volume proportion of 200:0.5:1; the nickel layer plus the copper layer have a thickness of 0.6 μm; and the tin layer has a thickness of 80 μm.

According to the aforementioned technical characteristics, the fuse structure has a tin layer made of tin, a silver layer made of silver, and a nickel layer made of nickel; the tin layer, the silver layer and the nickel layer have a volume proportion of 50:1:0.5˜220:1:0.5; the silver layer plus the nickel layer have a total thickness falling within a range of 0.15˜3 μm; and the tin layer has a thickness falling within a range of 5˜440 μm.

According to the aforementioned technical characteristics, the fuse structure has a tin layer made of tin, a silver layer made of silver, and a nickel layer made of nickel; the tin layer, the silver layer and the nickel layer have a volume proportion of 150:1:0.5; the silver layer plus the nickel layer have a total thickness of 0.6 μm; and the tin layer has a thickness of 80 μm.

According to the aforementioned technical characteristics, the fuse structure has a tin layer made of tin, a copper layer made of copper, a nickel layer made of nickel, and a chromium layer made of chromium; the tin layer, the copper layer, the nickel layer and the chromium layer have a volume proportion of 80:1:0.5:0.125˜300:1:0.5:0.125; the copper layer plus the nickel layer plus the chromium layer have a total thickness falling within a range of 0.1625˜3.25 μm; and the tin layer has a thickness falling within a range of 8˜600 μm.

According to the aforementioned technical characteristics, the fuse structure has a tin layer made of tin, a copper layer made of copper, a nickel layer made of nickel, and a chromium layer made of chromium; the tin layer, the copper layer, the nickel layer and the chromium layer have a volume proportion of 120:1:0.5:0.125; the copper layer plus the nickel layer plus the chromium layer have a total thickness of 0.6 μm; and the tin layer has a thickness of 92 μm.

Each low melting point metal layer of the fuse structure has a melting point falling within a range of 60˜350 degrees C., and each high melting point metal layer of the fuse structure has a melting point falling within a range of 600˜1900 degrees C.

Each low melting point metal layer of the fuse structure is made of a metal selected from the group consisting of tin, indium and bismuth; each high melting point metal layer of the fuse structure is made of a metal selected from the group consisting of aluminum, silver, copper, nickel, chromium, iron, gold, platinum, palladium and titanium.

Each metal layer of the fuse structure is constructed and formed by a method selected from the group consisting of sputtering, evaporation, chemical plating, ion plating, electroplating and vapor deposition.

Each metal layer of the fuse structure is constructed to be substantially in a rectangular profile.

Each metal layer of the fuse structure is constructed to be substantially in an H-shaped profile.

Each metal layer of the fuse structure is constructed to be substantially in a serpentine profile.

The shielding structure is made of a material selected from the group consisting of epoxy resin, polystyrene (PS), polyamide (PA), polycarbonate, polyphenylene ether and rubber.

The shielding structure is manufactured and formed by a method selected from the group consisting of coating, screen printing, spraying, vapor deposition and evaporation.

The thin protection element is coupled to a high melting point electrically conductive material between the fuse structure and each electrode.

The thin protection element is coupled to a high melting point electrically conductive material between the fuse structure and each electrode, and the total volume of the high melting point electrically conductive materials is substantially equal to the volume of the fuse structure.

In the thin protection element of the present invention, the shielding structure made of an insulating thermoplastic material is coated directly onto the surface of the fuse structure by the film formation technology, and thus the invention can reduce the total volume of the protection element effectively to facilitate the development of thin products. Specifically, the structural design of the fuse structure formed by at least two layers of different melting points and installed between the at least two electrodes not just offers more diversified product specifications to the protection element only, but also provides a broader range of selecting the metal to avoid using a metal that produces toxic substances, and helps passing the RoHS standard of the protection element.

### BRIEF DESCRIPTION OF THE DRAWINGS

FIG. 1 is a cross-sectional view of a conventional protection element;

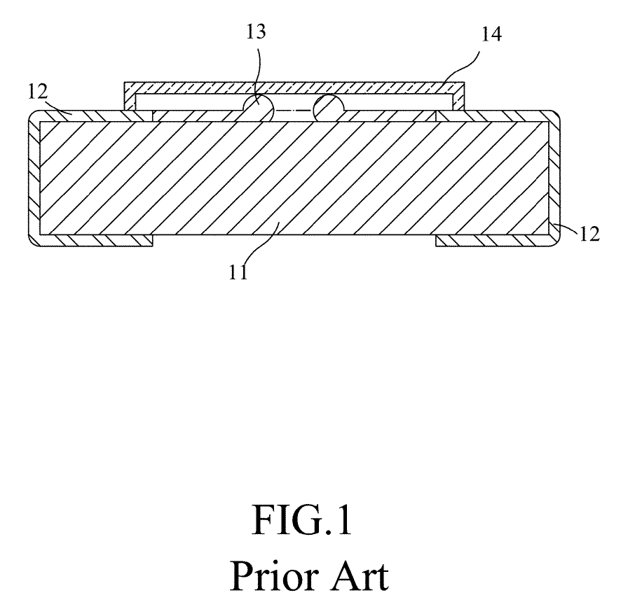

FIG. 2 is a cross-sectional view of a thin protection element in accordance with a first preferred embodiment of the present invention.

FIG. 3 is a perspective view of a thin protection element in accordance with the first preferred embodiment of the present invention.

FIG. 4 is an exploded view of a thin protection element in accordance with the first preferred embodiment of the present invention.

FIG. 5 is a schematic view showing a shielding structure together with the protrusion of a melted and deformed fuse structure in accordance with the present invention;

FIG. 6 is a cross-sectional view of a thin protection element in accordance with a second preferred embodiment of the present invention;

FIG. 7 is a cross-sectional view of a thin protection element in accordance with a third preferred embodiment of the present invention;

FIG. 8 is a schematic view of a fuse structure of a thin protection element in accordance with a fourth preferred embodiment of the present invention; and

FIG. 9 is a schematic view of a fuse structure of a thin protection element in accordance with a fifth preferred embodiment of the present invention.

### DESCRIPTION OF THE PREFERRED EMBODIMENTS

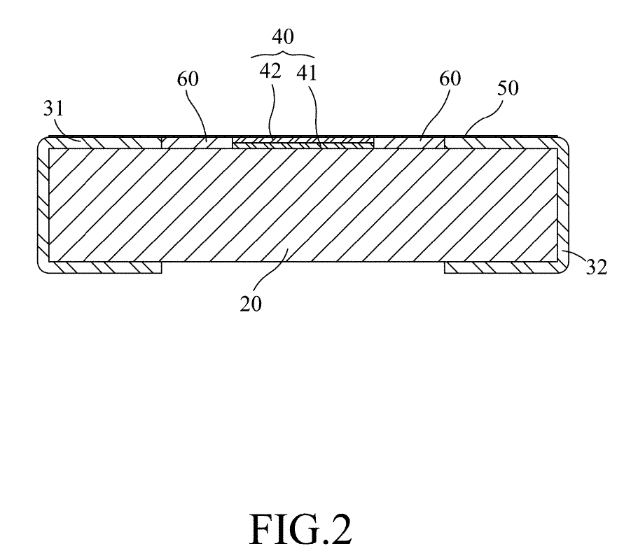

The present invention provides a protection element capable of reducing the total volume effective to facilitate the development of thin products. With reference to FIGS. 2 to 4 for a thin protection element of the present invention, the thin protection element comprises at least two electrodes 31, 32 installed on an insulating substrate 20 and provided for electrically connecting an external circuit, a fuse structure 40 electrically coupled between the at least two electrodes 31, 32 for fusing at a predetermined temperature, and a shielding structure 50 for at lease shielding the fuse structure 40.

The present invention is characterized in that the shielding structure 50 is made of an insulating thermoplastic material and directly coated onto a surface of the fuse structure 40 by a film formation technology. In an embodiment, the shielding structure 50 is made of a material selected from the group consisting of epoxy resin, polystyrene (PS), polyamide (PA), polycarbonate, polyphenylene ether and rubber and manufactured by a method selected from the group consisting of coating, screen printing, spraying, vapor deposition and evaporation.

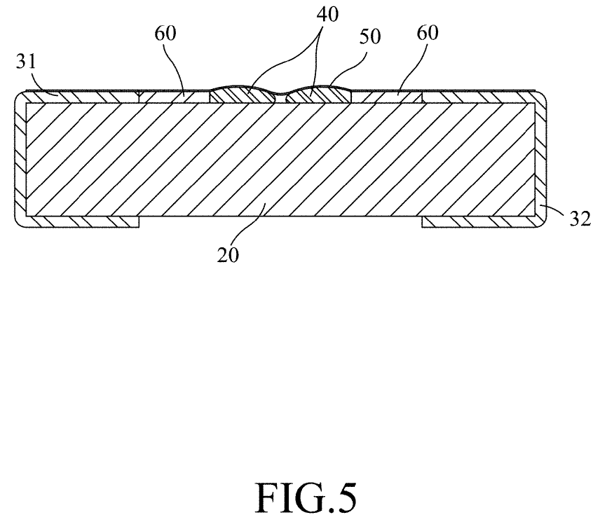

In FIG. 5, when a surge current exceeding a predetermined current value passes through the thin protection element of the present invention, the fuse structure 40 is melted by high temperature, and the shielding structure 50 is deformable according to the protrusion of the melted fuse structure 40, so as to provide an excellent ductility at high temperature and prevent the protruded fuse structure 40 from being ruined or damaged, and the invention can reduce the total volume of the protection element effectively to facilitate the development of thin product.

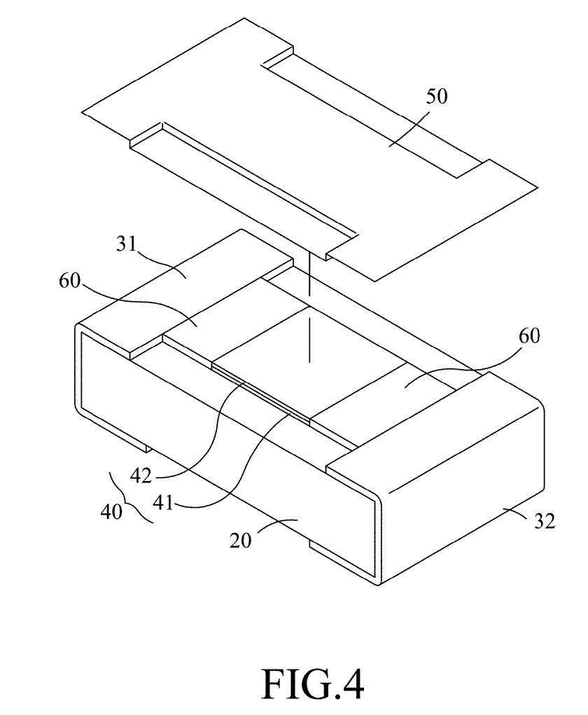

In a thin protection element of a preferred embodiment of the present invention, the fuse structure 40 is made of an alloy, and formed by stacking two metal layers of different melting points as shown in FIGS. 2 and 4; and the fuse structure 40 has a high melting point metal layer 41 and a low melting point metal layer 42 sequentially installed from bottom to top, or a low melting point metal layer and a high melting point metal layer sequentially installed from bottom to top.

Regardless of the fuse structure made of an alloy or formed by stacking two metal layers of different melting points, the whole thin protection element may be coupled to a high melting point electrically conductive material 60 between the fuse structure 40 and each electrode to further reduce the volume of the fuse structure 40 as well as the protrusion formed when the fuse structure is melted by high temperature. In such structure, the total volume of the high melting point electrically conductive materials 60 is preferably equal to the volume of the fuse structure 40.

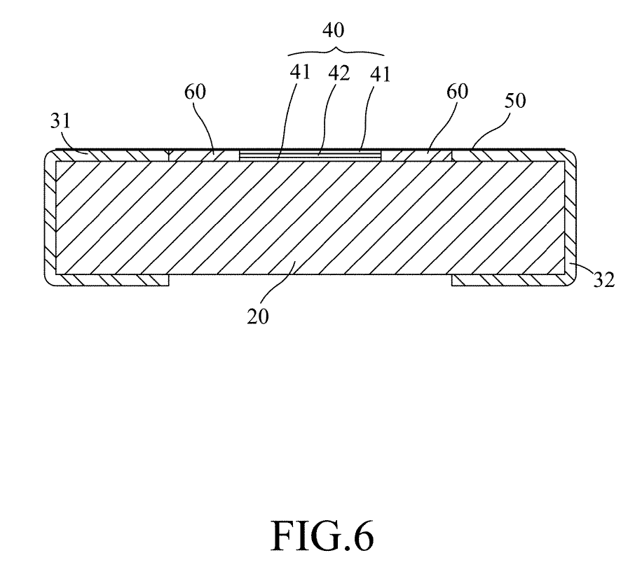

In a thin protection element of a preferred embodiment of the present invention, the fuse structure 40 has a high melting point metal layer 41, a low melting point metal layer 42 and a high melting point metal layer 41 sequentially installed from bottom to top as shown in FIG. 6; or a low melting point metal layer, a high melting point metal layer and a low melting point metal layer sequentially installed from bottom to top; or a high melting point metal layer, a high melting point metal layer and a low melting point metal layer sequentially installed from bottom to top.

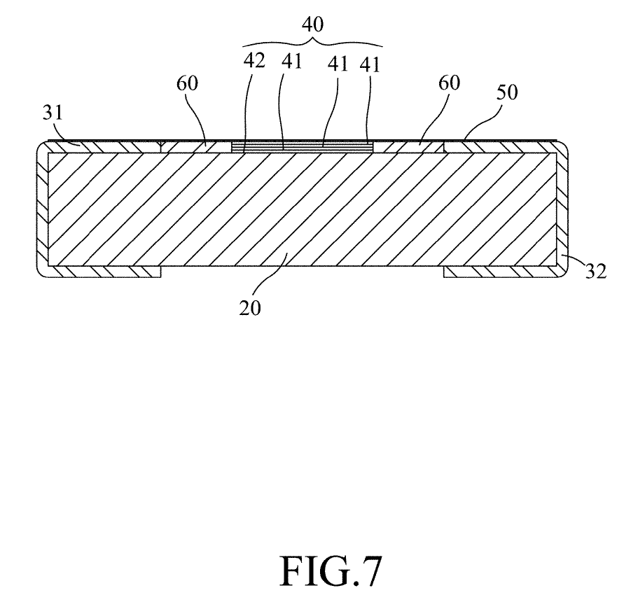

In FIG. 7, the fuse structure 40 has a low melting point metal layer 42, a high melting point metal layer 41, a high melting point metal layer 41 and a high melting point metal layer 41 sequentially installed from bottom to top; a high melting point metal layer, a low melting point metal layer, a high melting point metal layer and a high melting point metal layer sequentially installed from bottom to top; or a high melting point metal layer, a high melting point metal layer, a low melting point metal layer and a high melting point metal layer sequentially installed from bottom to top; or a high melting point metal layer, a high melting point metal layer, a high melting point metal layer and a low melting point metal layer sequentially installed from bottom to top.

Each low melting point metal layer has a melting point falling within a range of 60˜350 degrees C., and each high melting point metal layer has a melting point falling within a range of 600˜1900 degrees C. Each low melting point metal layer is made of a metal selected from the group consisting of tin, indium and bismuth, and each high melting point metal layer is made of a metal selected from the group consisting of aluminum, silver, copper, nickel, chromium, iron, gold, platinum, palladium and titanium.

In the preferred embodiment as shown in FIGS. 2 and 4, the thin protection element of the present invention has a fuse structure 40 installed between at least two electrodes 31, 32 and made of at least two metal layers of different melting points (which are a high melting point metal layer 41 and a low melting point metal layer 42 as shown in the figures), and normally all metal layers (including the high melting point metal layer 41 and the low melting point metal layer 42) of the fuse structure 40 are electrically conducted to the electrodes of the protection element, so that the protection element can be applied to a circuit that requires overcurrent or overvoltage protection.

When a surge current exceeding a predetermined current value passes through the fuse structure 40, the metal layer with a lower melting point (which is the low melting point metal layer 42) of the fuse structure 40 will be fused first, and then the metal layer with a higher melting point (which is the high melting point metal layer 41) of the fuse structure 40 will be melted by the high temperature to provide the fusing effect to protect the circuit from being damaged.

In particular, the mass ratio of the different metal layers can be adjusted to control the fusing temperature of the fuse structure, so as to achieve the effects of offering more diversified product specifications to the protection element, providing a broader range of selecting metals to avoid using a metal that produces toxic substances, and helping to pass the restriction of the use of certain hazardous substances in electrical and electronic equipment (RoHS) of the protection element.

In a first implementation mode of the present invention, the fuse structure has a tin layer made of tin and a copper layer made of copper; the tin layer and the copper layer have a volume ratio of 30:1˜120:1; the copper layer has a thickness falling within a range of 0.1˜2 μm; the tin layer has a thickness falling within a range of 3˜240 μm. In this implementation mode, the tin layer and the copper layer preferably have a volume ratio of 60:1; the copper layer preferably has a thickness of 1.5 μm; and the tin layer preferably has a thickness of 90 μm.

In a second implementation mode of the present invention, the fuse structure has a tin layer made of tin and a nickel layer made of nickel; the tin layer and the nickel layer have a volume ratio of 50:1˜160:1; the nickel layer has a thickness falling within a range of 0.1˜2 μm; and the tin layer has a thickness falling within a range of 5˜320 μm. In this implementation mode, the tin layer and the nickel layer preferably have a volume ratio of 90:1; the nickel layer preferably has a thickness of 1 μm; and the tin layer preferably has a thickness of 90 μm.

In a third implementation mode of the present invention, the fuse structure has a tin layer made of tin and a silver layer made of silver; the tin layer and the silver layer have a volume ratio of 25:1˜110:1; the silver layer has a thickness falling within a range of 0.1˜2 μm; and the tin layer has a thickness falling within a range of 2.5˜220 μm. In this implementation mode, the tin layer and the silver layer preferably have a volume ratio of 50:1; the silver layer preferably has a thickness of 1.5 μm; and the tin layer preferably has a thickness of 75 μm.

In a fourth implementation mode of the present invention, the fuse structure has a tin layer made of tin, a copper layer made of copper, and a silver layer made of silver; the tin layer, the copper layer and the silver layer have a volume proportion of 60:1:1˜240:1:1; the copper layer plus the silver layer have a total thickness falling within a range of 0.2˜4 μm; and the tin layer has a thickness falling within a range of 6˜480 μm. In this implementation mode, the tin layer, the copper layer and the silver layer preferably have a volume proportion of 120:1:1; the copper layer plus the silver layer preferably have a total thickness of 1.5 μm; and the tin layer preferably has a thickness of 90 μm.

In a fifth implementation mode of the present invention, the fuse structure has a tin layer made of tin, a nickel layer made of nickel, and a copper layer made of copper; the tin layer, the nickel layer and the copper layer have a volume proportion of 100:0.5:1˜320:0.5:1; the nickel layer plus the copper layer have a thickness falling within a range of 0.15˜3 μm; and the tin layer has a thickness falling within a range of 10˜640 μm. In this implementation mode, the tin layer, the nickel layer and the copper layer preferably have a volume proportion of 200:0.5:1; the nickel layer plus the copper layer preferably have a total thickness of 0.6 μm; and the tin layer preferably has a thickness of 80 μm.

In a sixth implementation mode of the present invention, the fuse structure has a tin layer made of tin, a silver layer made of silver, and a nickel layer made of nickel; the tin layer, the silver layer and the nickel layer have a volume proportion of 50:1:0.5˜220:1:0.5; the silver layer plus the nickel layer have a total thickness falling within a range of 0.15˜3 μm; and the tin layer has a thickness falling within a range of 5˜440 μm. In this implementation mode, the tin layer, the silver layer and the nickel layer preferably have a volume proportion of 150:1:0.5; the silver layer plus the nickel layer preferably have a total thickness of 0.6 μm; and the tin layer preferably has a thickness of 80 μm.

In a seventh implementation mode of the present invention, the fuse structure has a tin layer made of tin, a copper layer made of copper, a nickel layer made of nickel and a chromium layer made of chromium; the tin layer, the copper layer, the nickel layer and the chromium layer have a volume proportion of 80:1:0.5:0.125˜300:1:0.5:0.125; the copper layer plus the nickel layer plus the chromium layer have a total thickness falling within a range of 0.1625˜3.25 μm; the tin layer has a thickness falling within a range of 8˜600 μm. In this implementation mode, the tin layer, the copper layer, the nickel layer and the chromium layer preferably have a volume proportion of 120:1:0.5:0.125; the copper layer plus the nickel layer plus the chromium layer preferably have a total thickness of 0.6 μm; and the tin layer preferably has a thickness of 92 μm.

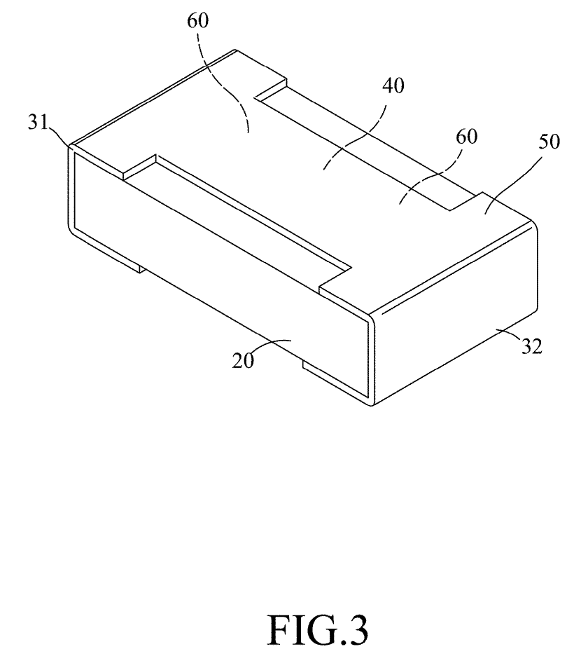

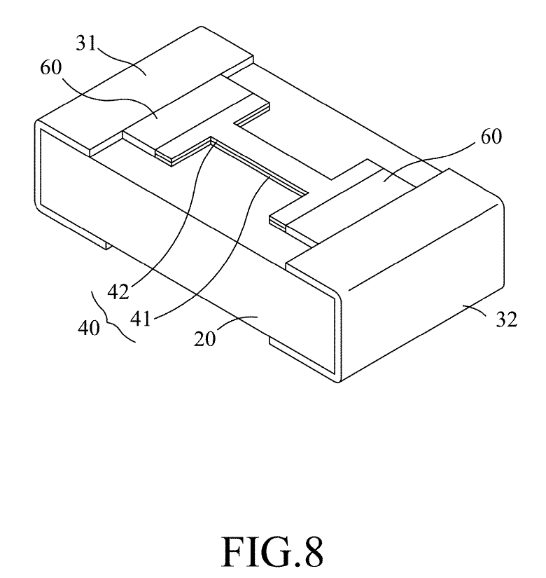

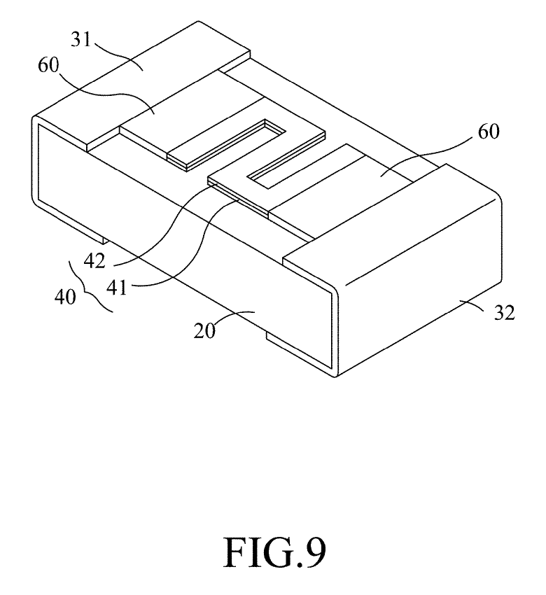

In the thin protection element as disclosed in different embodiments of the present invention, each metal layer is constructed or formed by a method selected from the group consisting of sputtering, evaporation, chemical plating, ion plating, electroplating and vapor deposition. It is noteworthy that all metal layers except the one in contact with the insulating substrate are constructed or formed by electroplating. Each metal layer (including the high melting point metal layer 41 and the low melting point metal layer 42 as shown in the figures) is constructed to be substantially in a rectangular profile as shown in FIG. 3, so that the whole fuse structure 40 can provide a one-time fusing effect with a smaller resistance value; each metal layer (including the high melting point metal layer 41 and the low melting point metal layer 42) may be constructed substantially in an H-shaped profile as shown in FIG. 8, so that the fusing position of the whole fuse structure 40 can be controlled easily; or each metal layer (including the high melting point metal layer 41 and the low melting point metal layer 42) may be constructed substantially in a serpentine profile as shown in FIG. 9, so that the whole fuse structure 40 can provide a one-time fusing effect with a greater resistance value.

Specifically, the shielding structure of the thin protection element of the present invention is made of an insulating thermoplastic material and directly coated onto a surface of the fuse structure by a film formation technology, and deformable to cope with the protrusion of the melted fuse structure to prevent the fuse structure from being ruined or damaged by the protrusion of the fuse structure. The invention can reduce the total volume of the protection element and facilitate the development of thin products effectively. In addition, the structural design of the fuse structure formed by at least two layers of different melting points and installed between the at least two electrodes not just offers more diversified product specifications to the protection element only, but also provides a broader range of selecting the metal to avoid using a metal that produces toxic substances, and helps passing the RoHS standard of the protection element.

While the invention has been described by means of specific embodiments, numerous modifications and variations could be made thereto by those skilled in the art without departing from the scope and spirit of the invention set forth in the claims.

What is claimed is:

1. A thin protection element, comprising: at least two electrodes, installed on an insulating substrate, for electrically coupling an external circuit; a fuse structure, electrically coupled between the at least two electrodes, for fusing at a predetermined temperature; and a shielding structure, for at least shielding the fuse structure, characterized in that the shielding structure is made of an insulating thermoplastic material and directly coated onto a surface of the fuse structure by a film formation technology.

2. The thin protection element of claim 1, wherein the fuse structure is made of an alloy.

3. The thin protection element of claim 1, wherein the fuse structure is formed by stacking two metal layers of different melting points.

4. The thin protection element of claim 1, wherein the fuse structure has a high melting point metal layer and a low melting point metal layer sequentially installed from bottom to top.

5. The thin protection element of claim 1, wherein the fuse structure has a low melting point metal layer and a high melting point metal layer sequentially installed from bottom to top.

6. The thin protection element of claim 1, wherein the fuse structure has a high melting point metal layer, a low melting point metal layer and a high melting point metal layer sequentially installed from bottom to top.

7. The thin protection element of claim 1, wherein the fuse structure has a low melting point metal layer, a high melting point metal layer and a low melting point metal layer sequentially installed from bottom to top.

8. The thin protection element of claim 1, wherein the fuse structure has a high melting point metal layer, a high melting point metal layer and a low melting point metal layer sequentially installed from bottom to top.

9. The thin protection element of claim 1, wherein the fuse structure has a low melting point metal layer, a high melting point metal layer, a high melting point metal layer and a high melting point metal layer sequentially installed from bottom to top.

10. The thin protection element of claim 1, wherein the fuse structure has a high melting point metal layer, a low melting point metal layer, a high melting point metal layer and a high melting point metal layer sequentially installed from bottom to top.

11. The thin protection element of claim 1, wherein the fuse structure has a high melting point metal layer, a high melting point metal layer, a low melting point metal layer and a high melting point metal layer sequentially installed from bottom to top.

12. The thin protection element of claim 1, wherein the fuse structure has a high melting point metal layer, a high melting point metal layer, a high melting point metal layer and a low melting point metal layer sequentially installed from bottom to top.

13. The thin protection element of claim 1, wherein the fuse structure has a tin layer made of tin and a copper layer made of copper; the tin layer and the copper layer have a volume ratio of 30:1˜120:1; the copper layer has a thickness falling within a range of 0.1˜2 μm; and the tin layer has a thickness falling within a range of 3˜240 μm.

14. The thin protection element of claim 1, wherein the fuse structure has a tin layer made of tin and a copper layer made of copper; the tin layer and the copper layer have a volume ratio of 60:1; the copper layer has a thickness of 1.5 μm; and the tin layer has a thickness of 90 μm.

15. The thin protection element of claim 1, wherein the fuse structure has a tin layer made of tin and a nickel layer made of nickel; the tin layer and the nickel layer have a volume ratio of 50:1˜160:1; the nickel layer has a thickness falling within a range of 0.1˜2 μm; and the tin layer has a thickness falling within a range of 5˜320 μm.

16. The thin protection element of claim 1, wherein the fuse structure has a tin layer made of tin and a nickel layer made of nickel; the tin layer and the nickel layer have a volume ratio of 90:1; the nickel layer has a thickness of 1 μm; and the tin layer has a thickness of 90 μm.

17. The thin protection element of claim 1, wherein the fuse structure has a tin layer made of tin and a silver layer made of silver; the tin layer and the silver layer have a volume ratio of 25:1˜110:1; the silver layer has a thickness falling within a range of 0.1˜2 μm; and the tin layer has a thickness falling within a range of 2.5˜220 μm.

18. The thin protection element of claim 1, wherein the fuse structure has a tin layer made of tin and a silver layer made of silver; the tin layer and the silver layer have a volume ratio of 50:1; the silver layer has a thickness of 1.5 μm; and the tin layer has a thickness of 75 μm.

19. The thin protection element of claim 1, wherein the fuse structure has a tin layer made of tin, a copper layer made of copper, and a silver layer made of silver; the tin layer, the copper layer and the silver layer have a volume proportion of 60:1:1˜240:1:1; the copper layer plus the silver layer have a total thickness falling within a range of 0.2˜4 μm; and the tin layer has a thickness falling within a range of 6˜480 μm.

20. The thin protection element of claim 1, wherein the fuse structure has a tin layer made of tin, a copper layer made of copper, and a silver layer made of silver; the tin layer, the copper layer and the silver layer have a volume proportion of 120:1:1; the copper layer plus the silver layer have a total thickness of 1.5 μm; and the tin layer has a thickness of 90 μm.

21. The thin protection element of claim 1, wherein the fuse structure has a tin layer made of tin, a nickel layer made of nickel, and a copper layer made of copper; the tin layer, the nickel layer and the copper layer have a volume proportion of 100:0.5:1˜320:0.5:1; the nickel layer plus the copper layer have a thickness falling within a range of 0.15˜3 μm; and the tin layer has a thickness falling within a range of 10˜640 μm.

22. The thin protection element of claim 1, wherein the fuse structure has a tin layer made of tin, a nickel layer made of nickel, and a copper layer made of copper; the tin layer, the nickel layer and the copper layer have a volume proportion of 200:0.5:1; the nickel layer plus the copper layer have a thickness of 0.6 μm; and the tin layer has a thickness of 80 μm.

23. The thin protection element of claim 1, wherein the fuse structure has a tin layer made of tin, a silver layer made of silver, and a nickel layer made of nickel; the tin layer, the silver layer and the nickel layer have a volume proportion of 50:1:0.5˜220:1:0.5; the silver layer plus the nickel layer have a total thickness falling within a range of 0.15˜3 μm; and the tin layer has a thickness falling within a range of 5˜440 μm.

24. The thin protection element of claim 1, wherein the fuse structure has a tin layer made of tin, a silver layer made of silver, and a nickel layer made of nickel; the tin layer, the silver layer and the nickel layer have a volume proportion of 150:1:0.5; the silver layer plus the nickel layer have a total thickness of 0.6 μm; and the tin layer has a thickness of 80 μm.

25. The thin protection element of claim 1, wherein the fuse structure has a tin layer made of tin, a copper layer made of copper, a nickel layer made of nickel, and a chromium layer made of chromium; the tin layer, the copper layer, the nickel layer and the chromium layer have a volume proportion of 80:1:0.5:0.125˜300:1:0.5:0.125; the copper layer plus the nickel layer plus the chromium layer have a total thickness falling within a range of 0.1625˜3.25 μm; and the tin layer has a thickness falling within a range of 8˜600 μm.

26. The thin protection element of claim 1, wherein the fuse structure has a tin layer made of tin, a copper layer made of copper, a nickel layer made of nickel, and a chromium layer made of chromium; the tin layer, the copper layer, the nickel layer and the chromium layer have a volume proportion of 120:1:0.5:0.125; the copper layer plus the nickel layer plus the chromium layer have a total thickness of 0.6 μm; and the tin layer has a thickness of 92 μm.

27. The thin protection element of claim 1, wherein the shielding structure is made of a material selected from the group consisting of epoxy resin, polystyrene (PS), polyamide (PA), polycarbonate, polyphenylene ether and rubber.

28. The thin protection element of claim 1, wherein the shielding structure is manufactured and formed by a method selected from the group consisting of coating, screen printing, spraying, vapor deposition and evaporation.

29. The thin protection element of claim 1, wherein the thin protection element is coupled to a high melting point electrically conductive material between the fuse structure and each electrode.

30. The thin protection element of claim 1, wherein the thin protection element is coupled to a high melting point electrically conductive material between the fuse structure and each electrode, and the total volume of the high melting point electrically conductive materials is substantially equal to the volume of the fuse structure.

31. The thin protection element of claim 3, wherein each metal layer of the fuse structure is constructed and formed by a method selected from the group consisting of sputtering, evaporation, chemical plating, ion plating, electroplating and vapor deposition.

32. The thin protection element of claim 3, wherein each metal layer of the fuse structure is constructed to be substantially in a rectangular profile.

33. The thin protection element of claim 3, wherein each metal layer of the fuse structure is constructed to be substantially in an H-shaped profile.

34. The thin protection element of claim 3, wherein each metal layer of the fuse structure is constructed to be substantially in a serpentine profile.

35. The thin protection element of claim 4, wherein each low melting point metal layer of the fuse structure has a melting point falling within a range of 60˜350 degrees C., and each high melting point metal layer of the fuse structure has a melting point falling within a range of 600˜1900 degrees C.

36. The thin protection element of claim 4, wherein each low melting point metal layer of the fuse structure is made of a metal selected from the group consisting of tin, indium and bismuth; each high melting point metal layer of the fuse structure is made of a metal selected from the group consisting of aluminum, silver, copper, nickel, chromium, iron, gold, platinum, palladium and titanium.
